(19) United States
(12) Patent Application Publication
(10) Pub. No.: US 2025/0016424 A1
(43) Pub. Date: Jan. 9, 2025

(54) Method for managing access to a content item to be read of a multimedia content item

(71) Applicant: ORANGE, Issy-les-Moulineaux (FR)

(72) Inventors: Hervé Marchand, CHATILLON CEDEX (FR); Mathieu Rivoalen, CHATILLON CEDEX (FR)

(21) Appl. No.: 18/704,734

(22) PCT Filed: Oct. 10, 2022
(86) PCT No.: PCT/EP2022/078099

§ 371 Date: Apr. 25, 2024

(30) Foreign Application Priority Data
Oct. 28, 2021 (FR) FR2111460

(51) Int. Cl. H04N 21/6405; H04N 21/262

(52) U.S. Cl. CPC H04N 21/6405; H04N 21/262

(57) ABSTRACT

A method for managing access, by a reading device, to a televised content item. The method includes: obtaining, for the same content item, a set of multicast broadcast channels associated with temporally spaced respective broadcast times. A request to access the content item made by the reading device includes selecting a multicast broadcast channel chosen from the set.

### TECHNICAL FIELD

The field of the invention is that of digital multimedia content, namely digital audio and/or video content (also called audiovisual content).

The invention more particularly relates to a method for managing reading of multimedia content.

The content in question here is content divided into chunks associated with a plurality of respective encoding rates selectable on request by a reader of multimedia streams.

A reader is any device capable of receiving multimedia streams, for example a decoder, a mobile telephone, a tablet, etc.

The content referred to here is content having a scheduled distribution time. Such content is for example “live” content delivered by a television channel.

### PRIOR ART

Sometimes the beginning of a televised program (movie, series, etc.) is missed. A function called “start over” or “restart” by those skilled in the art makes it possible, at any time, to restart the program currently being watched from its beginning. For example, if a movie starts at 8.50 p.m. on a distribution channel (a TV channel) and a user switches to this TV channel at 9.17 p.m., the user may actuate the “start over” function in order to be able to read the content from its beginning.

Generally, live content is distributed using multicast technology (also called “multipoint distribution” or “group broadcast” technology by those skilled in the art). This technology saves a lot of bandwidth in the network of an operator managing the distribution because the content is replicated as close as possible to the readers. However, when a reader needs to use the “start over” function, access to the requested content triggers an automatic switch from multicast technology to a point-to-point (unicast) content-distribution technology. Bandwidth consumption in the network of the operator therefore increases considerably because of the point-to-point transmission between the content server and all the readers having requested use of the “start over” function; for example, when the requested content is mass-market content, the number of point-to-point connections can become huge and lead to a bandwidth bottlenecking effect, which adversely affects network performance.

The invention offers a solution that does not have the drawbacks of the prior art.

### THE INVENTION

To this end, according to a first functional aspect, the subject of the invention is a method for managing access, by a reader, to televised content, characterized in that it comprises a step of obtaining, for given content, a set of multicast distribution channels associated with respective distribution times that are temporally spaced apart, and in that a content access request made by the reader comprises a step of selecting a multicast distribution channel chosen from said set.

According to the invention, when provision is made to multicast televised content on a distribution channel, a number of other multicast distribution channels are created for the same televised content with respective distribution times that are spread over time. When a request is made to read the content, a managing module will select one of the distribution channels from the set of distribution channels. Once the distribution channel has been selected, the reader transmits the content access request and specifies the desired channel for receipt of the content. In all cases, start over is therefore carried out in multicast. Using multicast mode instead of unicast mode ensures optimal playback quality and considerably reduces the network bandwidth required to access televised content in “start over” mode.

It will be seen below, according to one embodiment, the distribution of the content being scheduled for a given time, the content being in the process of being played back, that the method comprises the following steps:
selecting a channel from said set, the channel being chosen depending on the distribution time associated with the channel and said time of receipt of the access request; and
transmitting a content access request specifying the multicast channel selected for receipt of the content.

The plurality of distribution times on the various multicast channels makes it possible to select a channel judiciously depending on the time of the content access request.

According to a first embodiment, the channel selected to receive the content is the channel the content distribution time of which is closest to the time of the content access request. Although distributed in multicast mode, because the closest distribution time is selected, content in the process of being distributed on a channel is accessed, in start over mode, depending on whether the time is before or after the time of the content access request, either with a slight loss of the beginning of the content but without any delay before playback, or with a slight delay but in this case with the content played back in full. A mode that is very similar to the unicast mode in terms of access to content in start over mode is therefore obtained while optimizing the bandwidth on the network between the server and the reader.

As indicated above, the closest time may be an earlier distribution time. According to a first variant of the first embodiment, the selected channel is the channel the content distribution time of which precedes the time of receipt of the request. In this case, when access to the content is requested, the selected channel is by default the last channel created to date. As indicated above, according to this variant content is restarted with a slight loss of the beginning of the content but without any delay before playback.

As indicated above, the closest time may be a later time. According to a second variant of the first embodiment, the channel selected to receive the content is the channel the content distribution time of which is to come. In this case, when access to the content is requested, the selected channel is for example the next channel that will be created. As indicated above, according to this variant content is restarted with a slight delay but in this case with the content played back in full right from the start.

According to a second embodiment, which may be implemented as an alternative or in addition to the previous embodiment, a channel is deleted when playback of the content on that channel has ended. This second embodiment makes it possible to recover available channels to start over other televised content.

According to a third embodiment, which may be implemented as an alternative or in addition to the previous embodiments, all the distribution times are included in data representative of a program guide. In this third embodiment, the distribution times form part of description data associated with content. A managing entity has the role of accessing the distribution times and of selecting the optimal time.

According to a first hardware aspect, the invention relates to an entity for managing access to televised content the distribution of which is scheduled for a given time, characterized in that it comprises:
a module for selecting a multicast distribution channel chosen from said set following a content access request.

According to a third hardware aspect, the invention relates to a reader comprising a managing entity such as defined above.

According to a fourth hardware aspect, the invention relates to a computer program able to be implemented on an entity such as defined above, the program comprising code instructions that, when it is executed by a processor, carry out the selecting-method steps defined above.

According to a second functional aspect, the invention relates to a method for managing distribution of content having a scheduled distribution time, characterized in that it comprises:
a step of creating, for given content, a set of multicast distribution channels associated with respective distribution times that are temporally spaced apart,
a step of receiving a datum representative of said time chosen from said set,
a step of transmitting the content via the channel associated with the chosen time.

According to a sixth hardware aspect, the invention relates to an entity, called the second entity, for managing distribution of content having a scheduled distribution time, characterized in that it comprises:
a creating module able to create, for given content, a set of multicast distribution channels associated with respective distribution times that are temporally spaced apart,
a module for receiving a datum representative of said time chosen from said set,
a transmitting module able to transmit read content via the channel.

According to a seventh hardware aspect, the invention relates to a server comprising a second managing entity such as defined above.

According to an eighth hardware aspect, the invention relates to a computer program able to be implemented on a second managing entity such as defined above, the program comprising code instructions that, when it is executed by a processor, carry out the method steps defined with reference to the second functional aspect.

According to a ninth hardware aspect, the invention relates to a first data medium on which has been stored at least one series of program-code instructions for executing managing method such as defined with reference to the first functional aspect.

Lastly, according to a tenth hardware aspect, the invention relates to a first data medium on which has been stored at least one series of program-code instructions for executing a managing method such as defined with reference to the second functional aspect.

Such a storage medium may be any entity or device capable of storing the program. For example, the medium may comprise a storage means, such as a ROM, for example a CD ROM or a microelectronic circuit ROM, or even a magnetic recording means, for example a USB stick or a hard disk.

Furthermore, such a storage medium may be a transmissible medium such as an electrical or optical signal, which may be routed via an electrical or optical cable, by radio or by other means, so that the computer program contained therein can be executed remotely. The program according to the invention may in particular be downloaded over a network, the Internet for example.

Alternatively, the storage medium may be an integrated circuit into which the program is incorporated, the circuit being configured to execute or to be used in the execution of the aforementioned method.

The invention will be better understood on reading the following description, which is given by way of example with reference to the appended drawings, in which:

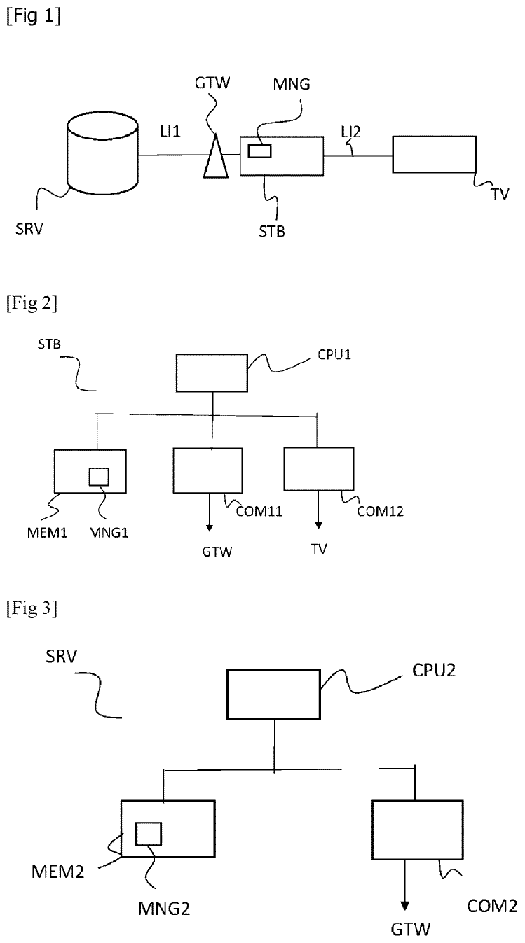

FIG. 1 shows a computer system in which one example of embodiment of the invention is illustrated;

FIG. 2 is a simplified block diagram of the hardware structure of the reader;

FIG. 3 is a simplified block diagram of the hardware structure of the server;

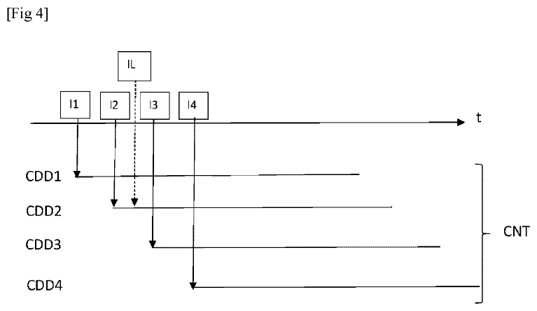

FIG. 4 illustrates a plurality of distribution channels for given content with distinct distribution times spread over time.

### DETAILED DESCRIPTION OF ONE EXAMPLE OF EMBODIMENT ILLUSTRATING THE INVENTION

FIG. 1 shows a computer system SYS in which a content distribution network (CDN) is implemented, from which content is transmitted to client devices or content readers.

In the example, the system comprises a single reader. However, the invention applies to any number of readers.

The reader is for example a decoder STB.

The multimedia content in question here is video content corresponding to a television channel on which are distributed televised programs having a start time corresponding to a scheduled distribution time and an end time.

A “start over” function is provided to allow content to be watched from the beginning when it has already started.

The computer system SYS comprises a reader STB of multimedia streams, for example a decoder connected to a rendering terminal TV such as a television.

In the example, the reader STB is connected to a port of the rendering device TV; the reader and the rendering device TV could also form a single device.

In the example, the reader STB is located in a local area network LAN managed by a residential gateway GTW. The context of the local network is given by way of example and could easily be transposed to a best-effort Internet network, to a company network, etc.

The gateway GTW is able to communicate via a telecommunication network LIL such as a wide area network (WAN) known to those skilled in the art.

The CDN consists of servers networked in the WAN; these servers interact in order to make multimedia content available to users. In order to simplify the description of the invention, a single content server SRV has been shown in FIG. 1 to represent the CDN.

In the example, the content server SRV is located in the WAN. The content server SRV for example receives channels of digital TV content from a broadcast television network (not shown) and makes them available to the client terminals, here the reader STB.

The content CNT is made available in a given format. Such content CNT is for example content downloaded in adaptive streaming mode. The standard MPEG-DASH (DASH standing for Dynamic Adaptive Streaming over HTTP) defines a standard format for distributing audiovisual content over the Internet; this standard is based on preparation of content into various representations of variable quality and bit rate, which are divided into chunks of short duration (of the order of a few seconds). Each of these chunks is made available individually by means of a protocol of exchange between the rendering terminal and the server providing the multimedia content. The protocol mainly targeted is HTTP, but other protocols (for example FTP) may also be used. The organization of the chunks and the associated parameters are published in a description file in XML format. Further details of this mode of downloading content will not be given since it is irrelevant to the description of the invention.

FIG. 2 shows an architecture of a reader STB. This reader STB conventionally comprises memories MEM1 associated with a processor CPU1. The memories may be read-only memories (ROMs) or random-access memories (RAMs) or flash memories.

The decoder STB is able to transmit content to be rendered to the rendering device TV via a communication module COM12. This module COM12 is for example an HDMI link.

The decoder STB communicates with the gateway via an Ethernet module (case of wired local communication) or via a Wi-Fi radio module (case of wireless local communication with the residential gateway GTW). The module in question is referenced CMO11 in FIG. 2.

The decoder STB comprises an entity for downloading in streaming mode (not shown) that is able to manage download of chunks. The decoder STB also comprises a managing entity MNG1, called the first managing entity below, the function of which will be described below.

With reference to FIG. 3, the server SRV is also equipped with at least one processor CPU2 and with memories MEM2, with a view to carrying out information processing. The server is also equipped with a managing entity MNG2, called the second entity, that is able to manage transmission of content from the server SRV to one or more readers. The server SRV communicates with the gateway GTW via the WAN, to communicate with the residential gateway GTW. The module in question is referenced CMO2 in FIG. 3.

According to the invention, the first managing entity MNG1 carries out the following steps:
a step of obtaining, for given content, a set of multicast distribution channels CDD1-CDD4 associated with respective distribution times I1-I4 that are temporally spaced apart,
   and, on receipt of a content access request by the reader:
a step of triggering a selection of a channel from said set;
a step of transmitting a content access request specifying the channel selected for receipt of the content.

The second entity MNG2 at its end carries out a step of creating, for given content, a set of multicast distribution channels on which the content will be transmitted at distribution times that are spread over time.

Next, when the second entity MNG2 detects receipt of a content access request, the second entity carries out the following steps:
a step of receiving a datum representative of said time chosen from said set,
a step of transmitting the content via the channel associated with the chosen time.

In other words, the second managing entity MNG2 creates a plurality of distribution channels and allocates these distribution channels to multicast distribution of the same televised content with distinct distribution times.

In the example, with reference to FIG. 4, a first distribution channel CDD1 is provided for distribution of televised content. The first channel and associated distribution time are those provided by default in a service plan of a content provider. This time may generally be consulted in a program guide in which all the televised content and distribution times appear. The program guide is generally accessible on request and displayed through a graphical interface.

According to the invention, considering televised content in particular, the second entity MNG2 will create a plurality of other multicast distribution channels for the same televised content. It will for example be assumed that the second managing entity MNG2 creates three other distribution channels CDD2-CDD4.

The channels CDD1-CDD4 are associated with respective distribution times I1 to I4 that are spread over time.

It will be noted that the number of channels may vary depending on the content and/or its duration. For example, if the content is mass-market content and therefore likely to be in high demand, a small spacing such as two seconds may be appropriate. It should be easily understood that, for a given temporal spacing, the longer the length of the content, the higher the number of distribution channels.

In other words, after distribution of content has started, at given times, for example every N minutes (every 2 minutes for example), a new multicast channel is created to distribute the content from its beginning. All the distribution channels are created and declared in a document called the live service plan.

It will be noted here that creation may consist in instantiation of a channel. It will be recalled that the service plan includes all the accessible television channels and other content such as video-on-demand or equivalent content. According to the invention, the service plan further comprises, for a televised program in the process of being distributed, data relating to the multicast channels and to the temporal spacing between the distribution times on these channels.

In one embodiment, the first managing entity MNG1 installed in the reader STB, after execution by the processor CPU1, will access information relating to the service plan offered by the server SRV and select one distribution channel from the plurality of channels CDD1-CDDn created for given content. It will be seen that the chosen distribution channel may be a channel currently being distributed or a channel that is still to be distributed.

Consider the example of a soccer match that is scheduled to be televised on a Saturday evening at 8.00 p.m. (I1=8.00 p.m.).

By way of example, the first four distribution channels CDD1-CDD4 (n=4) are allocated to the soccer match; other distribution channels may be allocated, but here only four will be considered to simplify the description.

The four channels will allow multicast distribution of the match at different times I1-I4, which are for example spaced apart by 10 minutes.

The various channels CDD1-CDD4 created are then transmitted to the reader STB. All four channels are included in the service plan. The service plan for example indicates that the match will be transmitted at 8.00 p.m. and that three other multicast transmissions will also take place at ten-minute intervals, i.e. at 8.10 p.m., 8.20 p.m. and 8.30 p.m.

The decoder STB then receives a request to access the content CNT. The access request may originate from an access command issued by a remote control able to remotely control the decoder STB.

With reference to FIG. 4, let it be assumed that the content access request is received at 8.11 p.m. (IL=8.11 p.m.). The first entity MNG1 receives this request.

Depending on the time of receipt of the content access request IL, the first managing entity MNG1 will select one distribution channel from among the available distribution channels and request receipt of the content via this channel.

The choice of the distribution channel is open to variants.

According to a first variant, the selected distribution channel is the channel the distribution time of which precedes the time of receipt of the access request IL. In the present case, the distribution time that precedes the access request IL is the latest to date, namely I2 (8.10 p.m.). This variant has the advantage of allowing the content to be accessed without delay because the content is already in the process of being distributed.

According to a second variant, the selected distribution channel is the one whose distribution time is after the time of receipt of the access request IL; the content has not yet been distributed on this channel. For example, the channel chosen is the channel the expected distribution time of which follows the time of receipt of the access request. In the present example, the selected channel is therefore the third distribution channel CDD3, the expected distribution time of which is I3 (8.20 p.m.), i.e. in a few minutes. In this case, the server has not started transmitting the content. There will therefore be a waiting period before the content is received; however, the content will be played back from the beginning. During the waiting period referred to above, a notification may be transmitted to advise of the waiting time before distribution of the content. It will be noted that the shorter the spacing between distribution times, the shorter the waiting time for receipt of the content.

The created distribution channels may have a limited or unlimited lifetime.

For example, when playback of a program via a distribution channel has ended, the channel in question is released to be used for distribution of other content. In other words, a distribution channel is created every N minutes from the start of content distribution; then the channel is deleted when the content distributed thereon has finished.

In contrast, distribution channels may be created for a television channel and be used constantly, each one being offset in time by 2 minutes for example. In this case it is no longer necessary to manage deletion of channels.

Lastly, it will be noted that the first managing entity MNG1 is equipped with the following modules for carrying out the invention:
a. a module for obtaining, for given content, a set of multicast distribution channels CDD1-CDD4 associated with respective distribution times I1-I4 that are temporally spaced apart,
b. a triggering module able to trigger, following a content access request, selection of a channel from said set—the channel being judiciously chosen depending on its distribution time and on said time of receipt of the access request13 and transmission of a content access request specifying the channel selected for receipt of the content.

The second entity for its part is equipped with the following modules for carrying out the method:
a. a creating module able to create, for given content, a set of multicast distribution channels CDD1-CDD4 associated with respective distribution times I1-I4 that are temporally spaced apart,
b. a module for receiving a datum representative of said time chosen from said set,
c. a transmitting module able to transmit read content via the channel.

Lastly, it will be noted here that the term module or the term entity may correspond either to a software component or to a hardware component or to a set of hardware and software component itself software components, a corresponding to one or more computer programs or subroutines or more generally to any element of a program able to implement a function or a set of functions such as described for the modules in question. In the same way, a hardware component corresponds to any element of a hardware assembly able to implement a function or a set of functions for the module in question (integrated circuit, chip card, memory card, etc.).

1. A managing method for managing access, by a reader, to televised content, wherein the method is implemented by the reader and comprises:
obtaining, for given content, a set of multicast distribution channels associated with respective distribution times that are temporally spaced apart; and
making a content access request including selecting a multicast distribution channel chosen from said set.

2. The managing method as claimed in claim 1, wherein the channel selected to receive the content is the channel the content distribution time of which is closest to a time of the content access request.

3. The managing method as claimed in claim 2, wherein the channel selected to receive the content is the channel the content distribution time of which precedes a time of the content access request.

4. The managing method as claimed in claim 2, wherein the channel selected to receive the content is the channel the content distribution time of which is to come.

5. The managing method as claimed in claim 1, comprising deleting a distribution channel when playback of the content on that channel has ended.

6. The managing method as claimed in claim 1, wherein all the distribution times are included in data representative of a program guide.

7. An entity for managing access to televised content, wherein the entity comprises:
at least one processor; and
at least one non-transitory computer readable medium comprising instructions stored thereon which when executed by the at least one processor configure the entity to implement a method for managing access, by a reader, to televised content, the method comprising:
obtaining, for given content, a set of multicast distribution channels associated with respective distribution times that are temporally spaced apart; and
selecting a multicast distribution channel chosen from said set following a content access request.

8. A non-transitory computer readable medium comprising a computer program stored thereon comprising code instructions that, when executed by a processor, implement a method for managing access, by a reader, to televised content, wherein the method comprises:
obtaining, for given content, a set of multicast distribution channels associated with respective distribution times that are temporally spaced apart; and
making a content access request including selecting a multicast distribution channel chosen from said set.

9. A method for managing distribution of content having a scheduled distribution time, wherein the method comprises:
creating, for given content, a set of multicast distribution channels associated with respective distribution times that are temporally spaced apart;
receiving a datum representative of a distribution time chosen from said set; and
transmitting the content via the channel associated with the chosen distribution time.

10. An entity for managing distribution of content having a scheduled distribution time, wherein the entity comprises:
at least one processor; and
at least one non-transitory computer readable medium comprising instructions stored thereon which when executed by the at least one processor configure the entity to implement a method comprising:
creating, for given content, a set of multicast distribution channels associated with respective distribution times that are temporally spaced apart;
receiving a datum representative of a distribution time chosen from said set; and
transmitting the content via the channel associated with the chosen distribution time.

11. The entity as claimed in claim 10, wherein the entity is implemented in a server.

12. A non-transitory computer readable medium comprising a computer program stored thereon comprising code instructions that, when executed by a processor, implement a method for managing distribution of content having a scheduled distribution time, wherein the method comprises:
creating, for given content, a set of multicast distribution channels associated with respective distribution times that are temporally spaced apart;
receiving a datum representative of a distribution time chosen from said set; and
transmitting the content via the channel associated with the chosen distribution time.
